(19) United States
(12) Patent Application Publication
(10) Pub. No.: US 2010/0318842 A1
(43) Pub. Date: Dec. 16, 2010

(54) CONTROLLER, STORAGE MEDIUM, AND INFORMATION CONTROL METHOD

(75) Inventor: Kunio UTSUKI, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/702,178

(22) Filed: Feb. 8, 2010

(30) Foreign Application Priority Data
Jun. 12, 2009 (JP) 2009-141583

(51) Int. Cl. G06F 11/00; G06F 12/00; G06F 11/07

(52) U.S. Cl. 714/6; 711/154; 714/E11.021; 711/E12.001

(57) ABSTRACT

According to one embodiment, a controller includes a receiver, an acquisition module, and a writer. The receiver receives information. The acquisition module acquires redundant information for correcting an error in the information. The writer writes the information to a first memory bank from a start address to a predetermined address of the first memory bank, and writes the redundant information to a second memory bank from the predetermined address to an end address of the second memory bank.

### CROSS-REFERENCE TO RELATED APPLICATIONS

This application is based upon and claims the benefit of priority from Japanese Patent Application No. 2009-141583, filed Jun. 12, 2009, the entire contents of which are incorporated herein by reference.

### BACKGROUND

1. Field

One embodiment of the invention relates to a controller that manages data and redundant information related to the data, a storage medium, and an information control method.

2. Description of the Related Art

Hard disk drive (HDD) devices have been provided with a memory to temporarily store data to be written to a magnetic disk. With the improvement of computer technology, the memory tends to have a larger capacity and be smaller in size.

When data is stored in the memory, an error is increasingly likely to occur. The use of an error correcting code (ECC) has been proposed to prevent such an error. Besides, there it a tendency that, to prevent an error from occurring in data received from a host system connected to the HDD device or in data read from a magnetic disk, various types of information such as a cyclic redundancy check (CRC) and a parity is assigned in advance to the data. Further, information that the user can handle or the like is sometimes assigned to the data. Hereinafter, such information assigned to data to be read/written will be referred to as redundant information.

For fast access to a memory such as a dynamic random access memory (DRAM) commonly used as a buffer memory, in general, the hard disk controller continuously performs burst access in the column direction. Data read by the burst access in the column direction is generally 512 bytes or a multiple thereof in length.

Since the size of data transferred between the hard disk controller and the host of the hard disk has been fixed to 512 bytes, data transfer to the DRAM can be achieved easily by the burst access.

However, as described above, it is a recent tendency that the size of data transferred from the host is not fixed to 512 bytes, but redundant information is attached to the data. In this case, if data of a fixed data length and the redundant information are continuously written to the DRAM, the data is stored in an odd form as crossing a row address or the like. This makes it difficult to manage an address pointer. Besides, the access speed to the memory decreases.

For example, Japanese Patent Application Publication (KOKAI) No. 2007-115390 discloses a conventional technology in which an error correcting code and data are stored in different memory banks. With the conventional technology, the error correcting code and the data can be read in parallel from the different memory banks. Thus, a decrease in access speed can be prevented.

In to the conventional technology, the location of the error correcting code varies according to the memory bank. This necessitates to control processing such as masking when data is read from/written to the memory with respect to each memory bank.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hardware configuration of a hard disk drive (HDD) device according to an embodiment of the invention;

FIG. 2 is an exemplary block diagram of a buffer block in the embodiment;

FIG. 3 is an exemplary schematic diagram of the arrangement of user data and redundant information written to a buffer RAM in the embodiment;

FIG. 4 is an exemplary table of a logical address of user data and the address of the user data written to the buffer RAM by a data write controller in the embodiment;

FIG. 5 is an exemplary table of a logical address of user data and the address of the user data written to the buffer RAM by the data write controller according to a modification of the embodiment;

FIG. 6 is an exemplary diagram for explaining the operation of an address specifying module to specify an address where redundant information is to be written in the embodiment;

FIG. 7 is an exemplary table of logical address conversion equations used by the address specifying module in the embodiment;

FIG. 8 is an exemplary diagram for explaining a logical address specified to write redundant information in the embodiment;

FIG. 9 is an exemplary diagram for explaining the logical address of redundant information when the buffer RAM is a 128-Mbit SDRAM, user data is 512 bytes in length, and redundant information is 16 bits in length in the embodiment;

FIG. 10 is an exemplary diagram for explaining the logical address of redundant information when the buffer RAM is a 128-Mbit SDRAM, user data is 512 bytes in length, and redundant information is 32 bits in length in the embodiment;

FIG. 11 is an exemplary flowchart of the operation of the HDD device to store data in the buffer RAM in the embodiment; and

FIG. 12 is an exemplary flowchart of the operation of the HDD device to read user data from the buffer RAM to send it to a reader/writer in the embodiment.

### DETAILED DESCRIPTION

Various embodiments according to the invention will be described hereinafter with reference to the accompanying drawings. In general, according to one embodiment of the invention, a controller comprises a receiver, an acquisition module, an information writer, and a redundant information writer. The receiver is configured to receive information. The acquisition module is configured to acquire redundant information for correcting an error in the information. The information writer is configured to write, upon receipt of the information, the information to at least a first memory bank of a plurality of memory banks of a storage module from the start address to a predetermined address of the first memory bank. The redundant information writer is configured to write, upon receipt of the information, the redundant information to a second memory bank other than the first memory bank from the predetermined address to the end address of the second memory bank.

According to another embodiment of the invention, a storage medium comprises a first memory bank and a second memory bank. The first memory bank is configured to store information from the start address to a predetermined address. The second memory bank is configured to store redundant information for correcting an error in the information from the predetermined address to the end address.

According to still another embodiment of the invention, there is provided an information control method comprising: a receiver receiving information; an acquisition module acquiring redundant information for correcting an error in the information; an information writer writing, upon receipt of the information, the information to at least a first memory bank of a plurality of memory banks of a storage module from the start address to a predetermined address of the first memory bank; and a redundant information writer writing, upon receipt of the information, the redundant information to a second memory bank other than the first memory bank from the predetermined address to the end address of the second memory bank.

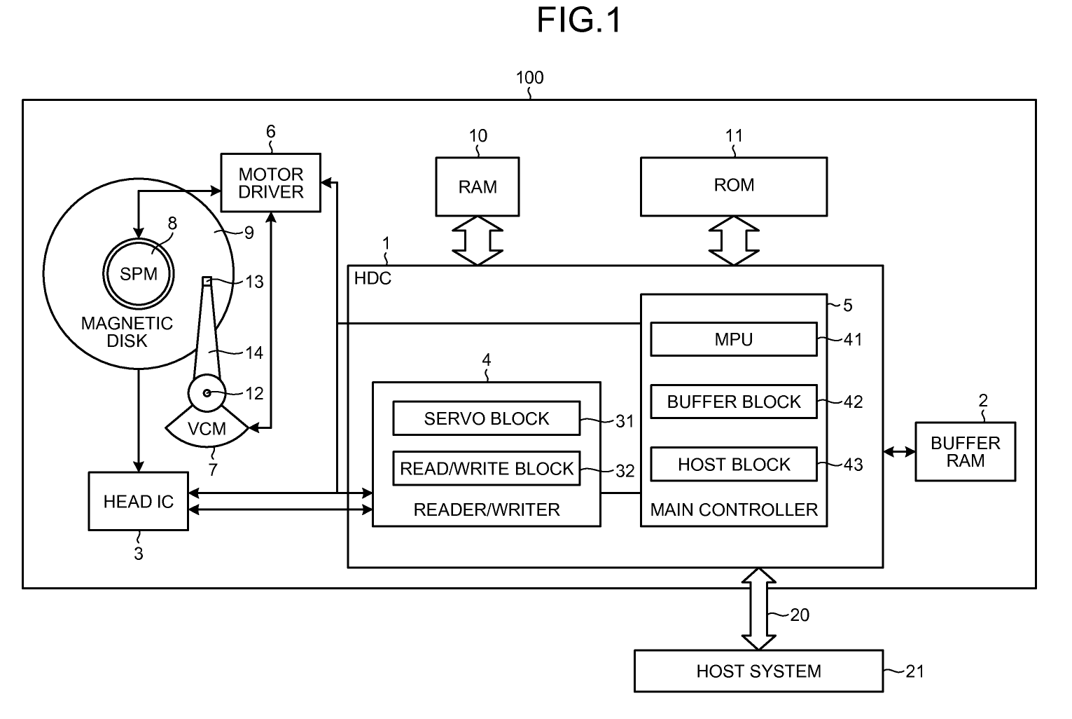

FIG. 1 is a block diagram of a hardware configuration of a hard disk drive (HDD) device 100 according to an embodiment of the invention. As illustrated in FIG. 1, the HDD device 100 comprises a hard disk controller (HDC) 1, a buffer random access memory (RAM) 2, a motor driver 6, a voice coil motor (VCM) 7, a spindle motor (SPM) 8, a magnetic disk 9, a RAM 10, a read only memory (ROM) 11, a magnetic head 13, an arm 14, a spindle 12, and a head integrated circuit (IC) 3. The HDD device 100 is connected to a host system 21 via a transmission path 20.

The SPM 8 is a motor that steadily rotates the magnetic disk 9. The VCM 7 comprises a magnet and a drive coil (both not illustrated), and is driven by power supplied from the motor driver 6 to move the magnetic head 13 to a desired position.

The motor driver 6 controls current that flows through the SPM 8 and the VCM 7 to drive them.

The magnetic disk 9 is provided with a track that is formed thereon with respect to each of the different radii. Each track has an area (data area) to store data received from the host system 21. The data area includes a plurality of readable/writable sectors. With this configuration of the magnetic disk 9, when moving along the radial direction of the magnetic disk 9, the magnetic head 13 can scan a sector of a track. While scanning the sector on the magnetic disk 9, the magnetic head 13 reads data from or writes data to the sector.

The magnetic head 13 is supported by the arm 14. The magnetic head 13 reads the position information of a track from servo data and also scans the magnetic disk 9 to read or write data. The arm 14 is driven by the VCM 7 and rotates about the spindle 12 to move the magnetic head 13 in the radial direction of the magnetic disk 9.

The head IC 3 has the function of, for example, amplifying a weak signal read by the magnetic head 13.

The ROM 11 stores a control program used by the HDC 1 (for example, a microprocessing unit (MPU) 41). The RAM 10 is used as a work area where the HDC 1 (for example, the MPU 41) stores a variable prime number and the like.

The HDC 1 is an integrated circuit (IC) designed to control the HDD device 100. The HDC 1 comprises a reader/writer 4 and a main controller 5.

The reader/writer 4 comprises a servo block 31 and a read/write block 32. The servo block 31 mainly performs signal processing necessary to position the magnetic head 13. The read/write block 32 performs signal processing necessary for a read/write operation.

The main controller 5 comprises the MPU 41, a buffer block 42, and a host block 43.

The host block 43 controls an interface to the host system 21. It is assumed herein that the host block 43 transmits data to/receives data from the host system 21 in units of 512 bytes.

The MPU 41 performs a read/write operation. The MPU 41 searches for a track to read data from or write data to the track, and manages the position where the data is to be read/written. To write data to or read data from a track obtained by the search, the MPU 41 issues an instruction to the reader/writer 4.

Described below is control based on a read request. An analog signal is read from the magnetic head 13 when the servo block 31 positions the magnetic head 13. The analog signal is amplified by the head IC 3 and is sent to the reader/writer 4 of the HDC 1. The reader/writer 4 decodes the amplified analog signal. The main controller 5 generates data to be transferred to the host system 21 from the decoded analog signal. The data is once stored in the buffer RAM 2, and then transferred to the host system 21.

Described below is control based on a write request. Data transferred from the host system 21 to the main controller 5 is once stored in the buffer RAM 2, and then is sent to the reader/writer 4 by the main controller 5. The reader/writer 4 encodes the data to be written. The data is written to the magnetic disk 9 by the magnetic head 13 through the head IC 3.

The buffer RAM 2 temporarily stores data read from the magnetic disk 9, data received from the host system 21, and the like. The data stored in the buffer RAM 2 is output to the reader/writer 4 or the host system 21.

The HDD device 100 of the embodiment uses a synchronous dynamic random access memory (SDRAM) as the buffer RAM 2. The buffer RAM 2 is assumed to comprise four memory banks. In each of the memory banks of the buffer RAM 2, the storage location of data can be specified by a row address and a column address.

High-speed burst access is performed continuously in the column direction in the buffer RAM 2. The size of the buffer RAM 2 is a multiple of 512 bytes in the column direction. Note that the buffer RAM 2 is not limited to SDRAM, and may be other memory units such as DRAM.

In the HDD device 100 of the embodiment, upon accessing to the buffer RAM 2, the plurality of memory banks can be accessed simultaneously in parallel (continuously) through memory interleave.

The buffer block 42 controls the buffer RAM 2. The configuration of the buffer block 42 will be described in detail below.

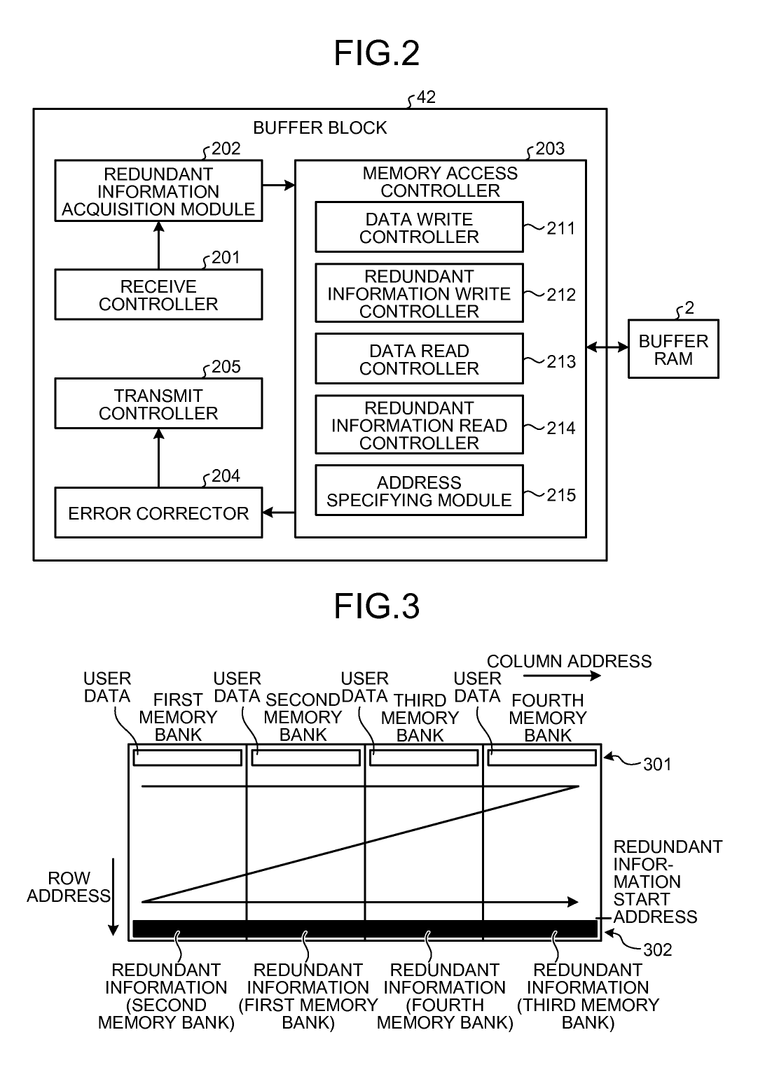

FIG. 2 is a block diagram of the configuration of the buffer block 42. As illustrated in FIG. 2, the buffer block 42 comprises a receive controller 201, a redundant information acquisition module 202, a memory access controller 203, an error corrector 204, and a transmit controller 205. The buffer block 42 controls a read/write operation with respect to the buffer RAM 2.

According to conventional technologies, data is transferred between the HDD device and the host system in units of 512 bytes. Since the size of the buffer RAM is a multiple of 512 bytes in the column direction, data transfer to the buffer RAM can be achieved easily by the burst access.

However, in recent years, the host system transfers data to which is attached data (redundant information) such as a parity, a cyclic redundancy check (CRC), and an error correcting code (ECC). Consequently, if the data is directly written to the buffer RAM, the data is stored in an odd location as crossing a bank address or a row address. This makes it difficult to manage an address pointer, and also reduces the access speed.

Therefore, in the HDD device 100 of the embodiment, redundant information such as a parity, CRC, ECC, etc. are stored all together in a memory bank other than the one that stores user data. With this, the user data can be managed in the same manner as the conventional technologies. In addition, both the user data and the redundant information can be accessed simultaneously in parallel (continuously) through memory interleave. Thus, a high-speed read/write operation can be achieved.

In the following, each element of the buffer block 42 will be described.

The receive controller 201 receives data from the host system. 21 through the host block 43. The receive controller 201 also receives data read from the magnetic disk 9 by the reader/writer 4. The received data is assumed to contain redundant information and user data.

The user data is data actually used in the host system 21 or the like. Examples of the user data include, in addition to text data, image data, and moving image data, software and the like. The user data has a structure in units of 512 bytes.

The redundant information is information related to the user data, and may be, for example, data assigned to the user data when the HDD device 100 and the host system 21 communicate the user data. Specific examples of the redundant information include a parity, CRC, ECC, and the like. The redundant information may also be a code or the like generated to correct an error in the user data in the HDC 1.

The receive controller 201 receives a read command to read data from the buffer RAM 2 from the reader/writer 4 or the host block 43. Upon receipt of the read command, a data read controller 213 determines that the reader/writer 4 is ready to write user data to the magnetic disk 9 or that the host block 43 is ready to transmit data to the host system 21. Accordingly, the data read controller 213 reads the user data from the buffer RAM 2.

The redundant information acquisition module 202 acquires redundant information from received data. While the redundant information acquisition module 202 of the embodiment acquires redundant information from received data, it is not so limited. For example, the redundant information acquisition module 202 may generate an error correcting code to correct an error in the user data, and use the error correcting code as redundant information.

The memory access controller 203 comprises a dada write controller 211, a redundant information write controller 212, the dada read controller 213, a redundant information read controller 214, and an address specifying module 215.

The memory access controller 203 of the embodiment enables user data and redundant information to be read simultaneously in parallel (continuously) from different memory banks of the buffer RAM 2 through memory interleave.

The address specifying module 215 specifies, based on the logical address of user data to be written/read, a logical address to/from which redundant information corresponding to the user data is to be written/read. How to specify the logical address will be described later.

In the embodiment, digits of a logical address are assigned to a row address, a memory bank, and a column address of the buffer RAM 2, respectively, in this order.

The address specifying module 215 of the embodiment specifies a logical address of redundant information such that a row address assigned thereto starts from a predetermined address to the end address and the redundant information is stored in a memory bank other than the one that stores user data.

Incidentally, it is assumed herein that the row address is 12 bits in length, and the predetermined address is “111111110000”.

Each time the receive controller 201 receives data, the dada write controller 211 writes user data contained in the data to at least one of the memory banks of the buffer RAM 2 from the start address to the predetermined address of the memory bank. While the dada write controller 211 is described above as writing user data each time data is received, it is not so limited. The dada write controller 211 may write user data according to the receipt of data.

Each time the receive controller 201 receives data, the redundant information write controller 212 writes redundant information acquired by the redundant information acquisition module 202 to an address specified by the address specifying module 215. Thus, the redundant information is written from the predetermined address to the end address in a memory bank other than the one to which user data is written. While the redundant information write controller 212 is described above as writing redundant information each time data is received, it is not so limited. The redundant information write controller 212 may write redundant information according to the receipt of data.

FIG. 3 is a schematic diagram of the arrangement of user data and redundant information written to the buffer RAM 2. As illustrated in FIG. 3, the buffer RAM 2 is provided with the first to fourth memory banks. In each of the first to fourth memory banks, an address to/from which data is to be written/read can be specified from a row address and a column address.

As illustrated in FIG. 3, the dada write controller 211 sequentially assigns digits of a logical address indicating where user data is to be written, from the uppermost bit, to a row address (from the start address to the predetermined address) of the buffer RAM 2 (SDRAM), a memory bank, and a column address. The dada write controller 211 then writes the user data to a memory cell specified by the row address, the memory bank, and the column address.

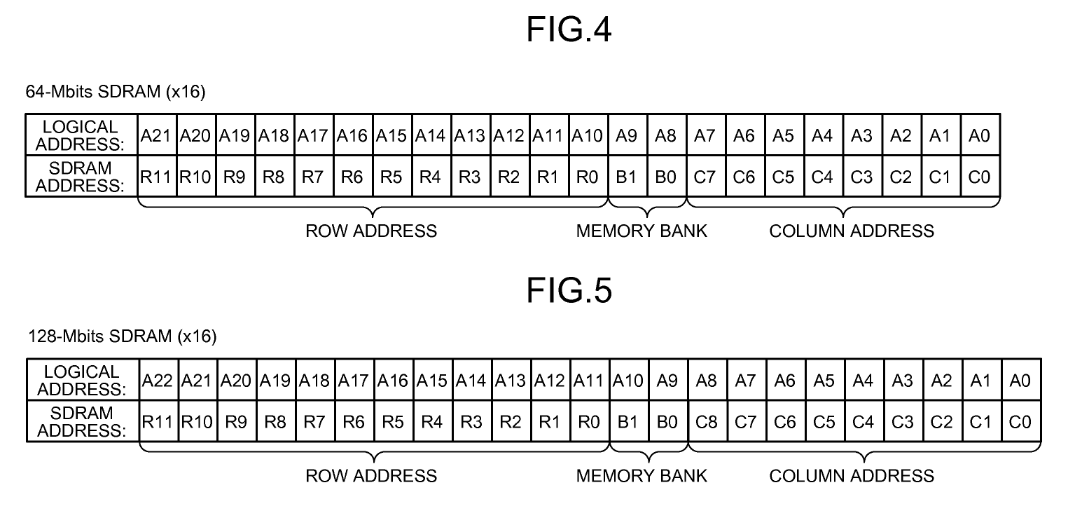

FIG. 4 is a table of a logical address of user data and the address of the user data written to the buffer RAM 2. In the example of FIG. 4, a 64-Mbit SDRAM (×16) is used as the buffer RAM 2. Assuming that a logical address where data is to be stored contains digits A21 to A0, the dada write controller 211 assigns the uppermost bit A21 to A10 (12 bits) to a row address, A9 and A8 (two bits) to a memory bank, and A7 to the lowermost bit A0 (eight bits) to a column address, thereby controlling writing of the user data.

In the embodiment, an example is described in which the buffer RAM 2 is a 64-Mbit SDRAM, user data is 512 bytes in length, and redundant information is 16 bits in length; however, the embodiment is not so limited. A modification of the embodiment will be described below.

FIG. 5 is a table of a logical address of user data and the address of the user data written to the buffer RAM 2. In the example of FIG. 5, a 128-Mbit SDRAM (×16) is used as the buffer RAM 2. Assuming that a logical address where data is to be stored contains digits A22 to A0, the dada write controller 211 assigns the uppermost bit A22 to A11 (12 bits) to a row address, A10 and A9 (two bits) to a memory bank, and A8 to the lowermost bit A0 (nine bits) to a column address, thereby controlling writing of the user data.

A description will be given of the case where user data is written with burst access according to the embodiment. The dada write controller 211 first writes user data to a memory cell specified by a column address in the first memory bank of a row address. The dada write controller 211 then writes the user data to a memory cell specified by a column address in the second memory bank of the row address. By repeating the write operation, after writing the user data to all memory cells each specified by a column address in the fourth memory bank of the row address, the dada write controller 211 writes the user data to a memory cell specified by a column address in the first memory bank of the next row address. In this manner, the dada write controller 211 can continuously write user data to a plurality of row addresses or memory banks.

After the dada write controller 211 writes user data to each of memory cells 301 in FIG. 3, the address specifying module 215 specifies a logical address to write redundant information corresponding to the user data such that the logical address is in a memory area 302.

More specifically, the address specifying module 215 fixes the upper digits orbits of the logical address of the redundant information to 1. The redundant information write controller 212 assigns digits of the specified logical address to a row address of the buffer RAM 2, a memory bank, and a column address, respectively, in this order. With this, the redundant information is stored as a whole in the end area (the memory area 302 in FIG. 3) after the predetermined address in the address space of the buffer RAM 2.

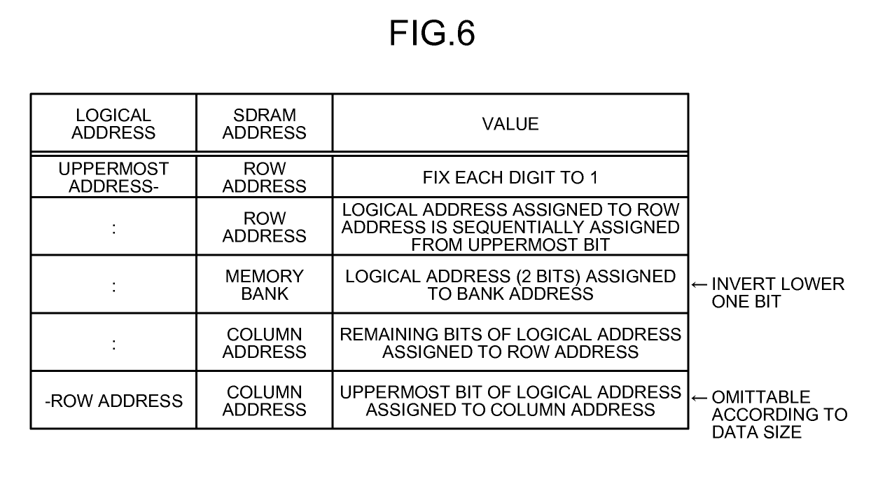

A specific description will be given of how the address specifying module 215 specifies the logical address of redundant information. FIG. 6 is a diagram for explaining the operation of the address specifying module 215 to specify an address where redundant information is to be written. As illustrated in FIG. 6, the values of the uppermost to predetermined bits of a logical address where redundant information is to be written are fixed to 1. After that, the address specifying module 215 sequentially assigns the values of bits of the logical address of user data (assigned to a row address), from the value of the uppermost bit, to other digits (bits) after the predetermined bit.

Different process is required to assign a digit to a bank address among digits of the logical address of the redundant information. Specifically, the address specifying module 215 sets the values of two digits (two bits) to be assigned to the bank address in the logical address of the redundant information based on the values of digits assigned to the bank address of the user data. More specifically, the address specifying module 215 sets the value of the upper one bit of the address of the user data as the upper one bit, while it sets the inverted value of the lower one bit of the address of the user data as the lower one bit. With this, the redundant information is written to a memory bank other than the one to which the data is written.

The address specifying module 215 then assigns the values of digits assigned to other row addresses and column addresses of the user data to other digits thereafter in the logical address of the redundant information. Depending on the data size of the buffer RAM 2 and redundant information, as illustrated in FIG. 6, it may be not necessary to assign “the upper bit of a logical address assigned to the column address of user data”.

The predetermined address to the end address of a row address are secured as an address to store redundant information. In the embodiment, a row address “11111111????” (?: 0 or 1) is used as an address to store redundant information, and it is forbidden to write user data and the like to the address.

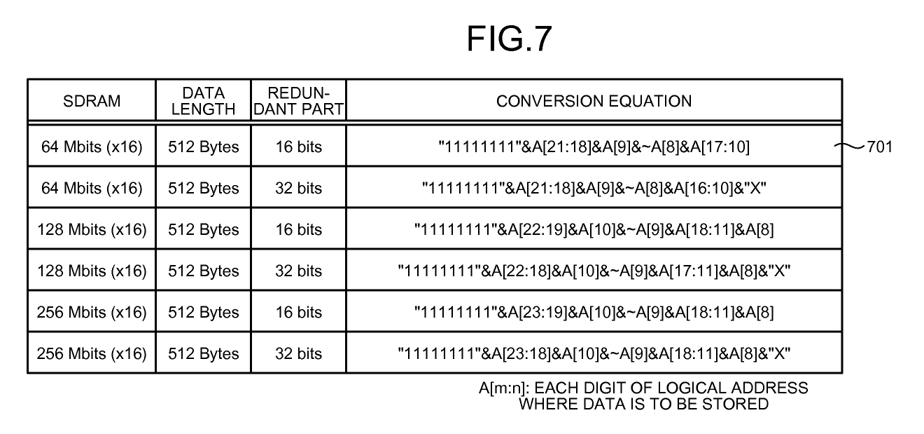

A description will be given of an equation for converting the logical address of user data to the logical address of redundant information related to the user data. FIG. 7 is a table of logical address conversion equations used by the address specifying module 215. Incidentally, in the embodiment, since it is assumed that the buffer RAM 2 is a 64-Mbit SDRAM and redundant information is 16 bits in length, only a conversion equation 701 is used. A[m:n] indicates the values of Am to An of the logical address of user data, and “˜” indicates that a value is inverted. By using the equation illustrated in FIG. 7, the address specifying module 215 can calculates the logical address of redundant information from the logical address of user data. The logical address obtained by using the equation will be described later.

The conversion equation 701 in FIG. 7 does not use A7 to A0 of the logical address of user data based on the difference in data size between the user data and the redundant information. That is, the data size of the user data is 512 bytes (=4096 bits), while the data size of the redundant information is 16 bits. Since 4096/16=256, a total of 256 pieces of redundant information can be stored in a storage area that can store one piece of user data. Accordingly, lower eight bits of the logical address of user data are not necessary.

Other equations in FIG. 7 are used for the case where at least one of the size of the SDRAM and the size of redundant information is different from the value described above. The HDC 1 may store all the equations as illustrated in FIG. 7 so that the address specifying module 215 can switch the equations according to the size of redundant information to be communicated and the capacity of the buffer RAM 2 of HDD device 100 provided with the HDC 1.

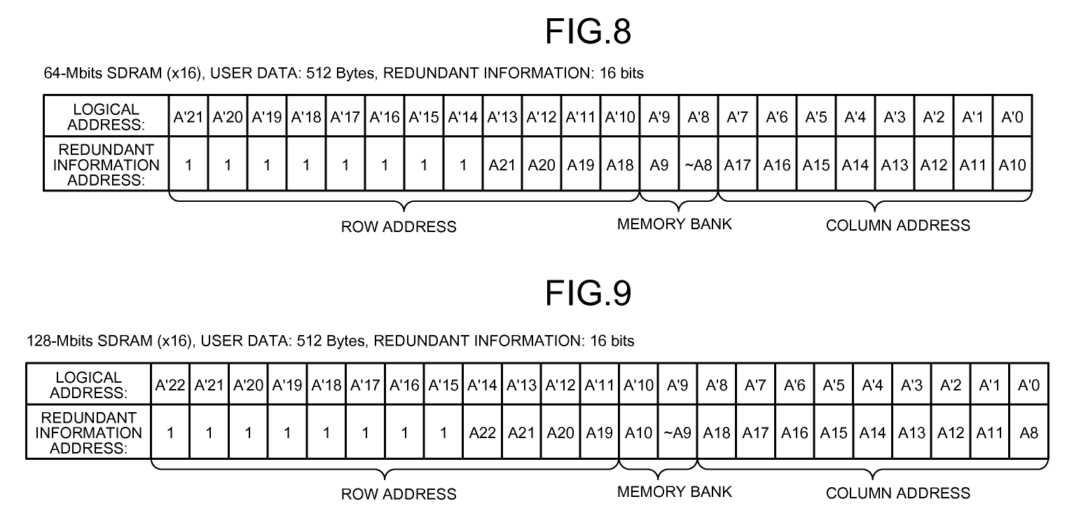

FIG. 8 is a diagram for explaining a logical address specified by the address specifying module 215 to write redundant information. It is assumed that the logical address is calculated based on the conversion equation 701 in FIG. 7. In FIG. 8, A21 to A0 indicate the values of digits of the logical address of user data, respectively, while A′21 to A′0 indicate the values of digits of the logical address of redundant information, respectively.

As illustrated in FIG. 8, 1 is set to A′21 to A′14 of the logical address of the redundant information. Further, the values of A21 to A18, A9, the inverted value of A8, and A17 to A10 of the logical address of the user data are set to A′13 to A′0. In this manner, by setting the inverted value of A8 to A′8, the redundant information can be stored in a different memory bank than the one that stores the user data.

The redundant information write controller 212 assigns, among the digits of the logical address of the redundant information, A′21 to A′10 to a row address, A′9 and A′8 to a memory bank, and A′7 and A′0 to a column address, thereby controlling writing of the redundant information.

The address specifying module 215 of the embodiment can specify a logical address to which redundant information is to be written by the simple calculation as described above. Thus, the operational load to specify an address can be reduced.

In the embodiment, an example is described with reference to FIG. 8 in which the buffer RAM 2 is a 64-Mbit SDRAM, user data is 512 bytes in length, and redundant information is 16 bits in length; however, the embodiment is not so limited. A modification of the embodiment will be described below.

FIG. 9 is a diagram of an example of the logical address of redundant information. In the example of FIG. 9, the buffer RAM 2 is a 128-Mbit SDRAM, user data is 512 bytes in length, and redundant information is 16 bits in length. As illustrated in FIG. 9, 1 is set to A′22 to A′15 of the logical address of the redundant information. Further, the values of A22 to A19, A10, the inverted value of A9, A18 to A11, and A 8 of the logical address of the user data are set to A′14 to A′0.

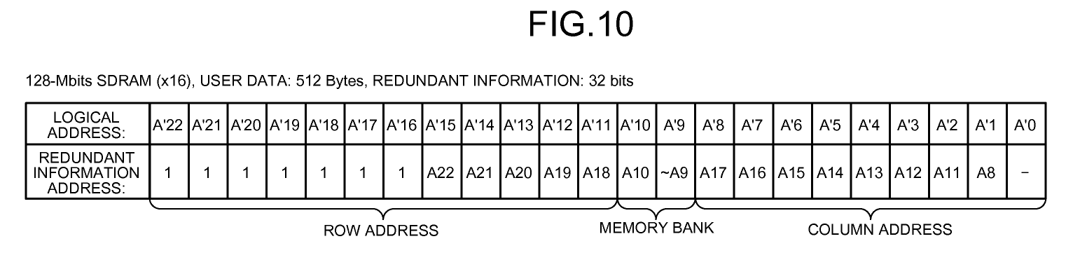

FIG. 10 is a diagram of another example of the logical address of redundant information. In the example of FIG. 10, the buffer RAM 2 is a 128-Mbit SDRAM, user data is 512 bytes in length, and redundant information is 32 bits in length. As illustrated in FIG. 10, 1 is set to A′22 to A′16 of the logical address of the redundant information. Further, the values of A22 to A18, A10, the inverted value of A9, A17 to A11, A 8, and “−” of the logical address of the user data are set to A′15 to A′0. Since the redundant information is 32 bits in length, A0 is not used, and therefore A0 is “−”.

According to the embodiment, by the write control as described above, redundant information is stored in a memory bank other than the one that stores user data. This prevents a plurality of times of SDRAM accesses (active to precharge) to write user data that occur when the user data and redundant information are stored in the same memory bank. Thus, it is possible to improve the use efficiency of the buffer RAM 2.

The data read controller 213 reads user data from at least one of the four memory banks of the buffer RAM 2.

Simultaneously in parallel (continuously), with that the data read controller 213 reads user data, the redundant information read controller 214 reads redundant information corresponding to the user data read by the data read controller 213 from an address specified by the address specifying module 215. Since the data read controller 213 and the redundant information read controller 214 reads data from different memory banks, they can read the data simultaneously in parallel (continuously). Thus, less time is taken to read the data.

When redundant information read by the redundant information read controller 214 contains a code or the like to correct an error, the error corrector 204 corrects user data read by the data read controller 213 using the code.

The transmit controller 205 sends read user data, and redundant information if required, to the reader/writer 4 or the host block 43.

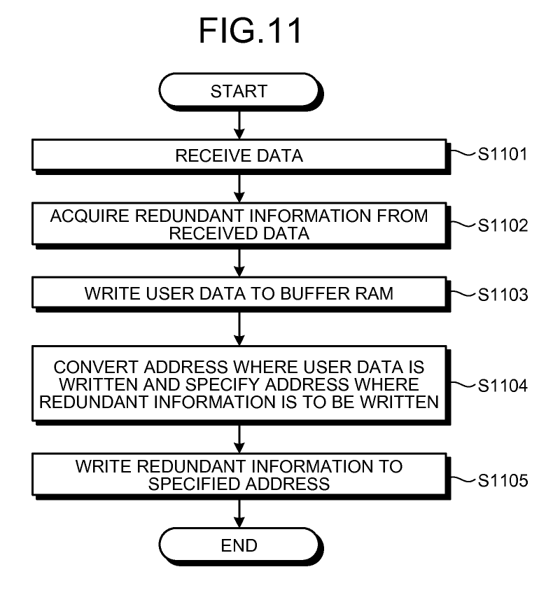

A description will be given of the operation of the HDD device 100 to store data received from the host system 21 in the buffer RAM 2. FIG. 11 is a flowchart of the operation of the HDD device 100 to store data in the buffer RAM 2.

First, the receive controller 201 receives data from the host system 21 (S1101). Then, the redundant information acquisition module 202 acquires redundant information from the received data (S1102). Incidentally, the redundant information acquisition module 202 need not necessarily acquire the redundant information from the received data. For example, from user data contained in the received data, the redundant information acquisition module 202 may generate an error correcting code to correct an error in the user data, and use the error correcting code as redundant information.

Thereafter, the dada write controller 211 writes user data contained in the received data to the buffer RAM 2 (S1103).

The address specifying module 215 converts the address where the user data is written at S1103 using the conversion equation as illustrated in FIG. 7, and specifies an address where the redundant information is to be written (S1104). By specifying the address where the redundant information is to be written using the conversion equation, the redundant information is stored in a different memory bank than the one that stores the user data, and the redundant information is stored in a predetermined row address area (the predetermined address to the end address) in the buffer RAM 2.

After that, the redundant information write controller 212 writes the redundant information acquired at S1102 to the address specified at S1104 (S1105).

With the process as described above, the redundant information and the user data can be stored in different memory banks, and thereby can be read simultaneously in parallel (continuously).

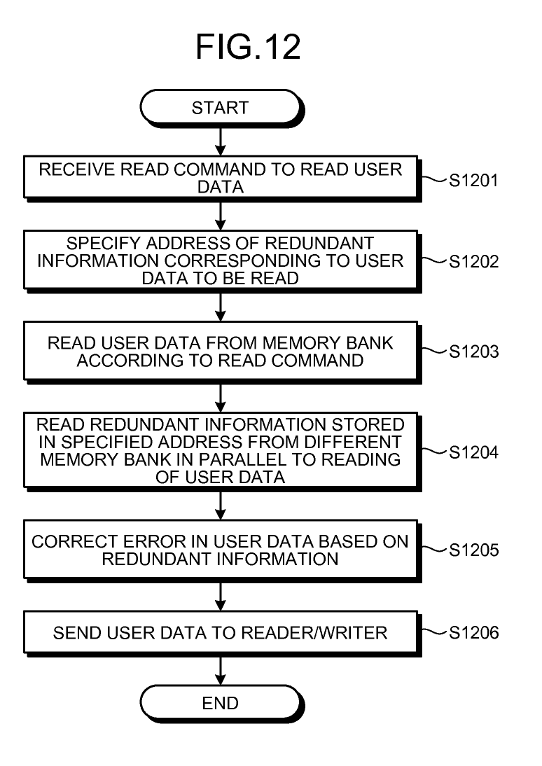

A description will be given of the operation of the HDD device 100 to read user data from the buffer RAM 2 to send it to the reader/writer 4. FIG. 12 is a flowchart of the operation of the HDD device 100 to read user data from the buffer RAM 2 to send it to the reader/writer 4.

First, the receive controller 201 receives a read command to read user data from the reader/writer 4 (S1201).

The address specifying module 215 specifies an address of redundant information corresponding to the user data to be read in response to the read command from an address where the user data is stored using the conversion equation as illustrated in FIG. 7 (S1202).

The data read controller 213 then reads the user data from a memory bank of the buffer RAM 2 according to the read command (S1203).

Through memory interleave, the redundant information read controller 214 reads the redundant information stored in the specified address from a different memory bank than the one that stores the user data in parallel (continuously) to reading of the user data (S1204).

After that, the error corrector 204 corrects an error in the read user data, if necessary, based on the read redundant information (an error correcting code, etc. contained therein) (S1205). The error correction may be performed in any way including commonly known ones, and it will not be described herein.

The transmit controller 205 sends the read user data, and the redundant information if required, to the reader/writer 4 (S1206).

As described above, the user data and the redundant information are stored in different memory banks, and therefore can be continuously accessed simultaneously in parallel (continuously). Thus, less time is taken to read the data.

The HDD device 100 of the embodiment provides an address offset algorithm that allows user data and redundant information to be stored in different memory banks so that they can be continuously accessed through bank interleave.

Moreover, according to the embodiment, along with access to user data, fast access to redundant information can be achieved through bank interleave.

Furthermore, according to the embodiment, with the use of the conversion equation (algorithm) as described above, user data is stored according to the column address of the buffer RAM 2. Thus, DRAM access as in conventional technologies is ensured to user data, and also fast or high-speed access is achieved to redundant information through memory interleave.

With this, in the HDD device 100 of the embodiment, it is possible to prevent the difficulty in managing an address pointer caused by that redundant information and user data are stored in the same storage area. In addition, extra accesses to data of small size, such as redundant information, can be prevented. This prevents the use efficiency of the buffer RAM 2 from being reduced.

Further, in the HDD device 100 of the embodiment, a different area than an area for storing user data is set to store redundant information. This facilitates the management of an address pointer.

According to the embodiment, each bit of a logical address is assigned to a row address, a memory bank, and a column address, and thereby the storage location of user data is uniquely determined. Therefore, address management is facilitated, which implements simple circuit mounting. Similarly, each bit of the logical address of redundant information is assigned to a row address, a memory bank, and a column address, and thereby the storage location of the redundant information is uniquely determined. Therefore, address management is facilitated, which also implements simple circuit mounting.

A computer program (hereinafter, “data processing program”) may be executed on a computer to realize the same function as the HDD device 100. The data processing program may be executed by the buffer block 42 in the HDC 1 and is provided as being stored in advance in ROM or the like.

The data processing program may be provided as being stored in a computer-readable storage medium, such as a CD-ROM, a flexible disk (FD), a compact disc-recordable (CD-R), or a digital versatile disc (DVD), in an installable or executable format.

The data processing program may also be stored in a computer connected via a network such as the Internet so that it can be downloaded therefrom via the network. Further, the data processing program may be provided or distributed via a network such as the Internet.

The data processing program comprises modules that implement the above constituent elements (the receive controller 201, the redundant information acquisition module 202, the memory access controller 203, the error corrector 204, and the transmit controller 205). As real hardware, the MPU 41 loads the data processing program from the ROM into the main memory and executes it. With this, the constituent elements, such as the receive controller 201, the redundant information acquisition module 202, the memory access controller 203, the error corrector 204, and the transmit controller 205, may be implemented on the main memory.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A controller comprising:
a receiver configured to receive information;
a redundant information extraction module configured to extract redundant information for correcting an error in the information;
a writer configured to write the information to a first memory bank from a start address to a predetermined address of the first memory bank, and to write the redundant information to a second memory bank from the predetermined address to an end address of the second memory bank.

2. The controller of claim 1, wherein the writer is configured to write the information and the redundant information upon the receipt of the information.

3. The controller of claim 1, further comprising a location module configured to locate an address of the redundant information based on an address of the information.

4. The controller of claim 3, wherein the writer is configured to assign digits of a first logical address of the information to the start address to the predetermined address of a row address of a storage module, a memory bank, and a column address, respectively, and to write the information to a storage area located by the row address, the memory bank, and the column address.

5. The controller of claim 4, wherein the location module is configured to set an inverted value of a digit of the first logical address of the memory bank as a digit of the second logical address of the memory bank.

6. A storage device comprising:
a storage medium comprising a first memory bank and a second memory bank, the first memory bank configured to store information from a start address to a predetermined address, and the second memory bank configured to store redundant information for correcting an error in the information from the predetermined address to an end address; and
a controller configured to control the storage medium.

7. An information control method comprising:
receiving information;
extracting redundant information for correcting an error in the information;
writing the information to a first memory bank from a start address to a predetermined address of the first memory bank, and writing the redundant information to a second memory bank from the predetermined address to an end address of the second memory bank.
